(19) United States
(12) Patent Application Publication
(10) Pub. No.: US 2015/0343470 A1
(43) Pub. Date: Dec. 3, 2015

(54) SPRAY MINERAL WATER BOTTLE AND CAP OF SPRAY MINERAL WATER BOTTLE

(71) Applicant: Sun Solutions LTD., Dongguan City (CN)

(72) Inventor: Chang Ho Chang, Taoyuan City (TW)

(21) Appl. No.: 14/824,381

(22) Filed: Aug. 12, 2015

Related U.S. Application Data
(63) Continuation-in-part of application No. 12/912,426, filed on Oct. 26, 2010.
Application No. 12/912,426 is a continuation-in-part of application No. 12/696,047, filed on Jan. 28, 2010, now abandoned.

(30) Foreign Application Priority Data
Oct. 19, 2010 (CN) 201010510654.0
Aug. 7, 2015 (CN) 201520591741.1

(51) Int. Cl. B05B 11/04; B05B 1/02; B05B 11/00

(52) U.S. Cl. CPC B05B 11/047; B05B 11/0032; B05B 1/02

(57) ABSTRACT

A cap of spray mineral water bottle includes a cap body, a spray member engaged to the cap body, and an on-off positioning member. The cap body includes a locating member defining an outlet in a low portion thereof. The spray member includes a spray portion, a handling portion, and a positioning post extending downwardly from a junction of the spray portion and the handling portion. The positioning post defines an inlet. The spray portion comprises an atomizing spool defining a receiving groove, a nozzle defining a cavity to receive the atomizing spool, and an accommodating part comprising a supporting bracket and an accommodating space to accommodate the nozzle, wherein the supporting bracket sticks into the receiving groove to support the atomizing spool. The on-off positioning member is positioned to the cap body to locate the spray member in an open position or a closed position.

### CROSS REFERENCE TO RELATED APPLICATIONS

This application is a continuation in part of and claims benefit of and priority to the following patent properties: (1) U.S. patent application Ser. No. 12/912,426, filed on Oct. 26, 2010, (2) U.S. patent application Ser. No. 12/696,047 filed Jan. 28, 2010, (3) U.S. patent application Ser. No. 12/757,202 filed Apr. 9, 2010, now U.S. Pat. No. 8,662,419, (4) Chinese Patent Application CN 201520591741.1, filed on Aug. 7, 2015, (5) Chinese Patent Application CN 201010510654.0 filed Oct. 19, 2010 and (6) Taiwan Patent Application TW 103136748, filed on Oct. 24, 2014, each of the above listed applications is hereby incorporated by reference herein as if set forth in its entirety.

### BACKGROUND

1. Technical Field

The invention relates to a mineral water bottle, and specially relates to a spray mineral water bottle and a cap of spray mineral water bottle.

2. Description of Related Art

The common cap of mineral water bottle includes a cap body which is screwed with a mineral water bottleneck, and the cap body is matched with mineral water bottleneck by means of liquid-tight fit. When you want to drink the mineral water in the bottle, you remove the cap and directly drink the water. This type of cap is used for sealing the mineral water inside the bottle body, and anti-fake function as well. This type of cap has simple functions so that the mineral water bottle matched with the cap has simple functions as well, which cannot satisfy the demands of daily life of people.

Presently the mineral water, which is taken outside the home, is mainly used for drinking When it is extremely hot or when you watch football in a stadium in the summer heat, you may want to spray the mineral water directly to your face or head to reduce temperature. However, if pouring mineral water, you may waste too much water and it cannot satisfy your demands due to insufficient water. In addition, temperature reduction effect is limited by this type of method and surrounding air cannot be improved if it is dusty. Therefore the conventional cap needs to be modified and perfected.

Therefore, a need exists in the industry to overcome the described problems.

### SUMMARY

A main object of the present invention is to improve the existing cap, to provide a cap of spray mineral water bottle with spray function.

In order to solve the problem, the disclosure offers technical proposal as follow.

A cap of spray mineral water bottle includes a cap body, a spray member engaged to the cap body, and an on-off positioning member. The cap body includes a locating member defining an outlet in a low portion thereof. The spray member includes a spray portion, a handling portion, and a positioning post extending downwardly from a junction of the spray portion and the handling portion. The positioning post defines an inlet. The spray portion comprises an atomizing spool defining a receiving groove, a nozzle defining a cavity to receive the atomizing spool, and an accommodating part comprising a supporting bracket and an accommodating space to accommodate the nozzle, wherein the supporting bracket sticks into the receiving groove to support the atomizing spool. The on-off positioning member is positioned on the cap body to locate the spray member in an open position or a closed position, wherein when the spray member is in the open position, the outlet communicates with the inlet; when the spray member is in the closed position, the outlet is staggered with the inlet.

The locating member comprises a recessing portion, a locating portion, and locating hole extending from the recessing portion through the locating portion.

A cross-section of the locating member is a Y shape, and a cross-section of the spray member is a Y shape corresponding to the Y shape of the cross-section of the locating member.

A cross-section of the recessing portion is a first slope, a cross-section of the spray portion is a second slope, and a cross-section of the handling portion next to the recessing portion is a third slope, wherein the first, second and third cross-sections are generally arranged with consistent angle.

The accommodating part and the handling portion are integrated.

The handling portion forms a first direction of the Y shape of the spray member, and the accommodating part extends from the first direction of the Y shape of the spray member to a second direction of the Y shape of the spray member and forms the second direction of the Y shape of the spray member.

The on-off positioning member comprises a pair of positioning portions, and each of the positioning portions comprises an L shaped positioning block to prevent from over rotation of the spray member.

Each of the positioning portions comprises a limiting protuberance and a camber part extending back the positioning block to the limiting protuberance, wherein the limiting protuberance is positioned at distal end of the camber part.

Because the cap of spray mineral water bottle includes the spray member, the cap of spray mineral water bottle can carry out spray drinking of water by means of squeezing the bottle body to transform bottle body and increase the pressure inside, thus making water to flow from the outlet into the inlet, and finally to be sprayed from the spray portion. Furthermore, in the open air or in the dusty and hot environment, you can place the spray mineral water bottle upside down, put the spray portion to face your body or surrounding, and squeeze the bottle body to spray, thus reducing surrounding temperature, as well as subsiding dust by combining dust and spray to make you feel cool, fresh and comfortable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a perspective view of a cap of spray mineral water bottle in accordance with the present invention.

FIG. 2 is a partially assembled view of FIG. 1.

FIG. 3 is an assembled view of FIG. 1.

FIG. 4 is a cross-sectional view of FIG. 2, showing a spray member in a closed position.

FIG. 5 is similar to FIG. 4, but showing the spray member in an open position.

FIG. 6 is an assembled of the cap of spray mineral water bottle of FIG. 1 and a bottle body.

FIG. 7 is an enlarged view of a circle portion VII of FIG. 4.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

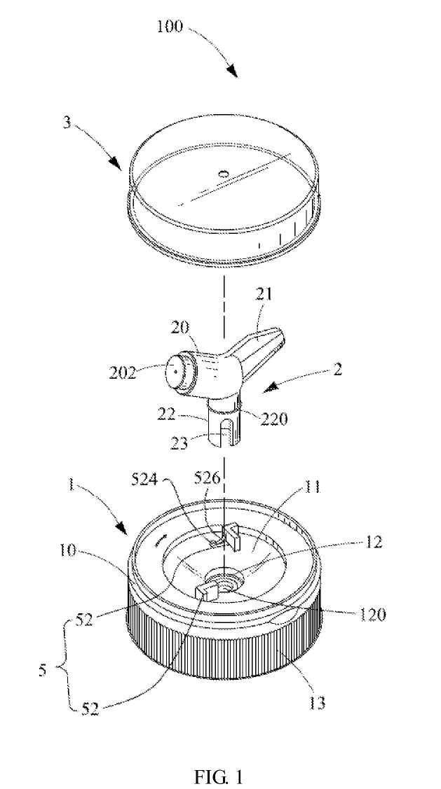

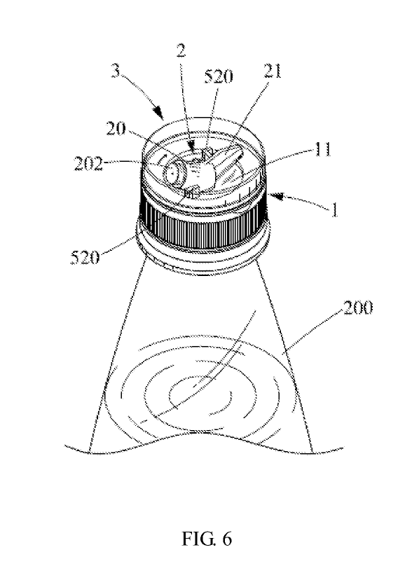

Refer to FIG. 1 and FIG. 6, a spray mineral water bottle includes a cap of spray mineral water bottle 100 and a bottle body 200, wherein the cap of spray mineral water bottle 100 includes a cap body 1, a spray member 2, a cover 3, and an on-off positioning member 5.

In one embodiment, the bottle body 200 is elastic, and by squeezing the bottle body 200, water in bottle body 200 can flow from the bottle body 200 into the cap of spray mineral water bottle 100.

Refer to FIG. 1 to FIG. 5, the cap body 1 includes a locating member 10 positioning at an upper portion thereof and a fixing member 13 positioning at a low portion thereof. The locating member 10 includes a recessing portion 11, a locating portion 12 positioning under the recessing portion 11, and a locating hole 120 extending from the recessing portion 11 through the locating portion 12. An outlet 121 is defined in an inner wall of the locating portion 12, i.e. the outlet 121 is defined in a low portion of the locating member 10. The fixing member 13 is fixed on the bottle body 200 by screw threads so that the cap of spray mineral water bottle 100 and the bottle body 200 are assembled into the spray mineral water bottle.

In one embodiment, a cross-section of the locating member 10 is a general Y shape. A surface of the recessing portion is a first slope.

A cross-section of the spray member 2 is a general Y shape corresponding to the Y shape of the cross-section of the locating member 10. The spray member 2 is assembled to the locating member 10 of the cap body 1. The spray member 2 includes a spray portion 20, a handling portion 21, and a positioning post 22 extending downwardly from a junction of the spray portion 20 and the handling portion 21.

The positioning post 22 defines an inlet 23 in an inner wall thereof. When the inlet 23 communicates with the outlet 121, the water flows from the bottle body 200 into the spray member 2. When the outlet 121 is staggered with the inlet 23, i.e. the outlet 121 is blocked by the inner wall of the positioning post 22, the water cannot flow from the bottle body 200 into the spray member 2.

The positioning post 22 includes a protuberance 220, and the locating portion 12 defines a slot 122 to receive the protuberance 220, resulting in that the spray member 2 can rotate relative to the cap body 1 rather than slide relative to the cap body 1.

Because of the Y shape of spray member 2 corresponding to the Y shape of the locating member 10, the spray member 2 falls deeply into the locating member 10 so that a height of a combination of the cap body 1 and the spray member 2 is lowered.

In detail, a cross-section of the spray portion 20 is a second slope. A cross-section of the handling portion 21 next to the recessing portion 11 is a third slope, wherein the first, second and third cross-sections are generally arranged with consistent angle, so that the spray member 2 falls deeply into the locating member 10, resulting in decreasing a thickness and a volume of the cap body 1.

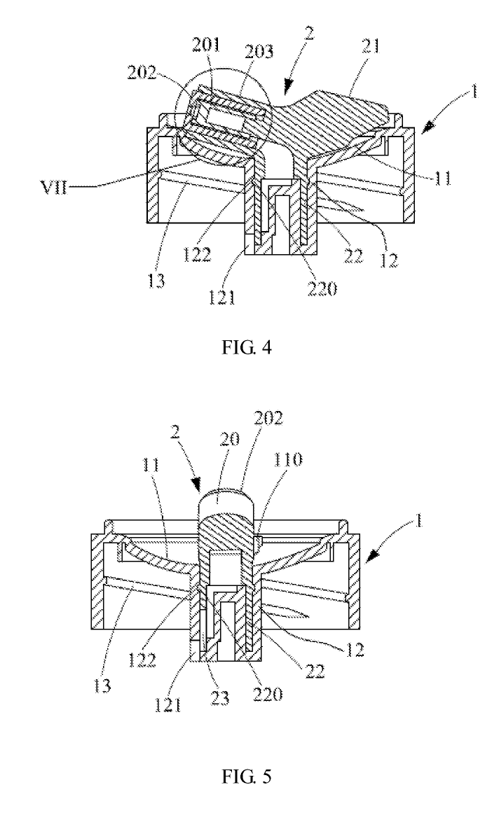

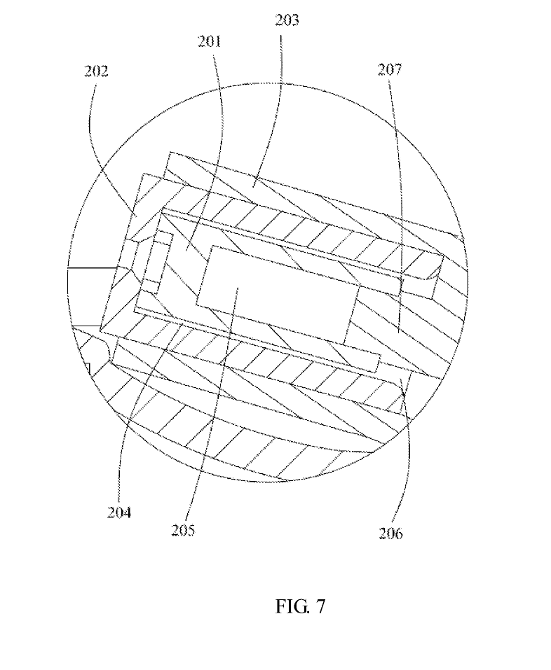

Referring to FIGS. 4 and 7, the spray portion 20 comprises an atomizing spool 201 defining a receiving groove 205, a nozzle 202 defining a cavity 204 to receive the atomizing spool 201, and an accommodating part 203 including a supporting bracket 207 and an accommodating space 206 to accommodate the nozzle 202. The supporting bracket 207 sticks into the receiving groove 205 to support the atomizing spool 201 resulting in increasing a strength of the spray portion 20 and preventing from deformation of the atomizing spool 201 the nozzle 202 under external force.

In one embodiment, the accommodating part 203 and the handling portion 21 are integrated, wherein the handling portion 21 forms a first direction of the Y shape of the spray member 2, and the accommodating part 203 extends from the first direction of the Y shape of the spray member 2 to a second direction of the Y shape of the spray member 2 and forms the second direction of the Y shape of the spray member 2. That is to say, the handling portion 21 forms the first direction of the Y shape of the spray member 2, the spray member 2 forms the second direction of the Y shape of the spray member 2, and the positioning post 22 forms a third direction of the Y shape of the spray member 2 because of the positioning post 22 extending downwardly from the junction of the spray portion 20 and the handling portion 21.

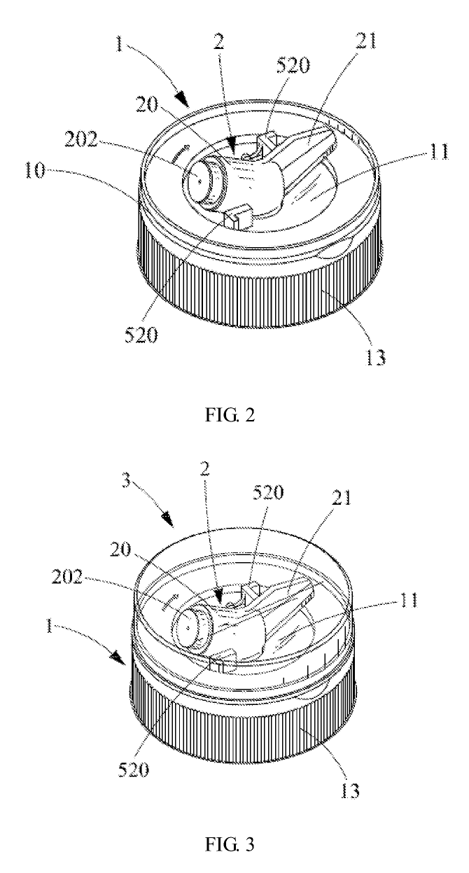

Referring to FIG. 2 and FIG. 3, the cover 3 is positioned on the locating member 10 to cover the cap body 1 to prevent from dust into the cape body 1, resulting in making it more hygienic.

Referring to FIG. 1 to FIG. 3, the on-off positioning member 5 is positioned on the recessing portion 11 to locate the spray member 2 in an open position or a closed position. The on-off positioning member 5 includes a pair of positioning portions 52, and each of the positioning portions 5 comprises an L shaped positioning block 520 to prevent from over rotation of the spray member 2, a limiting protuberance 524 and a camber part 526 extending back the positioning block to the limiting protuberance 524. The limiting protuberance 524 is positioned at distal end of the camber part 526 to prevent from auto on/off of the spray member 2 without external force. That is to say, the spray member 2 must be rotated by the external force to cross over the limiting protuberance 524 so that the spray member 2 can move from the closed position to the open position or from the open position to the closed position, and the limiting protuberance 524 is to prevent leakage from the cap of spray mineral water bottle 100 and accident spray of the spray member 2.

In one embodiment, a radian of the camber part 526 corresponds to a radian of the spray portion 20, resulting in facilitating location of between the spray portion 20 and the camber part 526.

Referring to FIG. 1 to FIG. 7, in assembly, the spray member 2 is inserted into the locating hole 120 together with the slot 122 receiving the protuberance 220, so that the spray member 2 is assembled to the cap body 1. The fixing member 13 is fixed to the bottle body 200, and the cover 3 is positioned on the cap body 1, thus the cap of spray mineral water bottle 100 and the bottle body 200 are assembled into the spray mineral water bottle.

In use, to spray water for cooling or drink water, the cover 3 is disengaged from the cap body 1, the spray member 2 is rotated to the open position relative to the cap body 1 by the external force applying force on the handling portion 21, the outlet 121 communicates with the inlet 23, the water flows from the bottle body 200 into the cap body 100 and the spray portion 20 sprays atomization of water by means of squeezing the bottle body 200 to transform bottle body 200 and increase the pressure inside, then, the spray member 2 is rotated to the closed position relative to the cap body 1 by the external force applying force on the handling portion 21, the outlet 121 is staggered with the inlet 23 and is blocked by the inner wall of the positioning post 22. After use, the cover 3 is assembled to the cap body 1 to cover the spray member 2, resulting in preventing from dust into the spray member 2 and the locating member 10.

Because the spray member 2 includes the handling portion 21, user only need applies force on the handling portion 21, the spray member 2 can rotate relative to the cap body 1 from the open position to the closed position or from the closed position to the open position during use. That is to say, the handling portion 21 enhances use convenience of the spray member 2, i.e. the handling portion 21 enhances use convenience of the spray mineral water bottle.

Because the spray mineral water bottle includes the spray member 2, the spray mineral water bottle can carry out spray drinking of water by means of squeezing the bottle body 200 to transform bottle body 200 and increase the pressure inside, thus making water to flow from the outlet 121 into the inlet 23, and finally to be sprayed from the spray portion 20. Furthermore, in the open air or in the dusty and hot environment, you can place the spray mineral water bottle upside down, put the spray portion 20 to face your body or surrounding, and squeeze the bottle body 200 to spray, thus reducing surrounding temperature, as well as subsiding dust by combining dust and spray to make you feel cool, fresh and comfortable.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A cap of spray mineral water bottle, comprising:
a cap body comprising a locating member defining an outlet in a low portion thereof;
a spray member engaged to the cap body, the spray member comprising a spray portion, a handling portion, and a positioning post extending downwardly from a junction of the spray portion and the handling portion, the positioning post defining an inlet; wherein the spray portion comprises an atomizing spool defining a receiving groove, a nozzle defining a cavity to receive the atomizing spool, and an accommodating part comprising a supporting bracket and an accommodating space to accommodate the nozzle, wherein the supporting bracket sticks into the receiving groove to support the atomizing spool; and
an on-off positioning member positioned to the cap body to locate the spray member in an open position or a closed position, wherein when the spray member is in the open position, the outlet communicates with the inlet; when the spray member is in the closed position, the outlet is staggered with the inlet.

2. The cap of spray mineral water bottle of claim 1, wherein the locating member comprises a recessing portion, a locating portion, and a locating hole extending from the recessing portion through the locating portion.

3. The cap of spray mineral water bottle of claim 2, wherein a cross-section of the locating member is a Y shape, and a cross-section of the spray member is a Y shape corresponding to the Y shape of the cross-section of the locating member.

4. The cap of spray mineral water bottle of claim 3, wherein a cross-section of the recessing portion is a first slope, a cross-section of the spray portion is a second slope, and a cross-section of the handling portion next to the recessing portion is a third slope, wherein the first, second and third cross-sections are generally arranged with consistent angle.

5. The cap of spray mineral water bottle of claim 3, wherein the accommodating part and the handling portion are integrated.

6. The cap of spray mineral water bottle of claim 5, wherein the handling portion forms a first direction of the Y shape of the spray member, and the accommodating part extends from the first direction of the Y shape of the spray member to a second direction of the Y shape of the spray member and forms the second direction of the Y shape of the spray member.

7. The cap of spray mineral water bottle of claim 1, the on-off positioning member comprises a pair of positioning portions, and each of the positioning portions comprises an L shaped positioning block to prevent from over rotation of the spray member.

8. The cap of spray mineral water bottle of claim 7, wherein each of the positioning portions comprises a limiting protuberance and a camber part extending back the positioning block to the limiting protuberance, wherein the limiting protuberance is positioned at distal end of the camber part.

9. A spray mineral water bottle, comprising:
a bottle body; and
a cap of spray mineral water bottle engaged to the bottle body, the cap of spray mineral water bottle comprising:
a cap body comprising a locating member defining an outlet in a low portion thereof;
a spray member engaged to the cap body, the spray member comprising a spray portion, a handling portion, and a positioning post extending downwardly from a junction of the spray portion and the handling portion, the positioning post defining an inlet; wherein the spray portion comprises an atomizing spool defining a receiving groove, a nozzle defining a cavity to receive the atomizing spool, and a accommodating part comprising a supporting bracket and an accommodating space to accommodate the nozzle, wherein the supporting bracket sticks into the receiving groove to support the atomizing spool; and
an on-off positioning member positioned to the cap body to locate the spray member in an open position or a closed position, wherein when the spray member is in the open position, the outlet communicates with the inlet; when the spray member is in the closed position, the outlet is staggered with the inlet.

10. The spray mineral water bottle of claim 9, wherein the locating member comprises a recessing portion, a locating portion, and locating hole extending from the recessing portion through the locating portion.

11. The spray mineral water bottle of claim 10, wherein a cross-section of the locating member is a Y shape, and a cross-section of the spray member is a Y shape corresponding to the Y shape of the cross-section of the locating member.

12. The spray mineral water bottle of claim 11, wherein a cross-section of the recessing portion is a first slope, a cross-section of the spray portion is a second slope, and a cross-section of the handling portion next to the recessing portion is a third slope, wherein the first, second and third cross-sections are generally arranged with consistent angle.

13. The spray mineral water bottle of claim 11, wherein the accommodating part and the handling portion are integrated.

14. The spray mineral water bottle of claim 13, wherein the handling portion forms a first direction of the Y shape of the spray member, and the accommodating part extends from the first direction of the Y shape of the spray member to a second direction of the Y shape of the spray member and forms the second direction of the Y shape of the spray member.

15. The spray mineral water bottle of claim 9, the on-off positioning member comprises a pair of positioning portions, and each of the positioning portions comprises an L shaped positioning block to prevent from over rotation of the spray member.

16. The spray mineral water bottle of claim 15, wherein each of the positioning portions comprises a limiting protuberance and a camber part extending back the positioning block to the limiting protuberance, wherein the limiting protuberance is positioned at distal end of the camber part.
